(19) United States
(12) Patent Application Publication
(10) Pub. No.: US 2020/0290010 A1
(43) Pub. Date: Sep. 17, 2020

(54) METHOD AND APPARATUS FOR REDUCING VAPOR BYPASS IN A DISTILLATION COLUMN HAVING STRUCTURED PACKING

(71) Applicants: Arya Ayaskanta, Tonawanda, NY (US); Paul William Belanger, Clarence Center, NY (US); Daniel M. Seiler, Lockport, NY (US); Kirk F. Larson, Amherst, NY (US); Di Song, Amherst, NY (US)

(72) Inventors: Arya Ayaskanta, Tonawanda, NY (US); Paul William Belanger, Clarence Center, NY (US); Daniel M. Seiler, Lockport, NY (US); Kirk F. Larson, Amherst, NY (US); Di Song, Amherst, NY (US)

(21) Appl. No.: 16/352,909

(22) Filed: Mar. 14, 2019

(51) Int. Cl. B01J 19/32; B01D 3/32

(52) U.S. Cl. CPC B01J 19/32; B01D 3/32; B01J 2219/32408; B01J 2219/32237; B01J 2219/32262; B01J 2219/3221

(57) ABSTRACT

A structured packing arrangement for reducing vapor bypass in the gaps between the edges of structured packing elements or bricks and the packed distillation column wall is provided. The structured packing arrangement includes a high pressure drop shroud attached to portions of the perimeter of the structured packing elements and in the gap between the edge of the structured packing elements and the interior surface of the distillation column wall. The high pressure drop shroud urges the ascending vapor flowing at or near the edges of the structured packing elements to stay within the structured packing elements instead of escaping through the side of the structured packing toward the distillation column wall.

### TECHNICAL FIELD

The present invention relates to a structured packing arrangement for packed distillation columns, and more particularly to a method and apparatus for reducing vapor bypass in the gaps between the structured packing and the packed distillation column wall.

### BACKGROUND

Distillation columns with structured packing have been used in industrial applications since the 1960's including, for example, distillation applications in chemistry, petroleum chemistry, refining, air separation, and adsorption. The structured packing provides a large surface area for vapor-liquid contacting within the column which increases the overall effectiveness of the distillation column.

Structured packing is typically formed by stacking together vertical sheets of corrugated metal, with the angle of the corrugations reversed in adjacent sheets to form a very open structure with inclined flow channels. To simplify installation, the structured packing is provided in pre-formed segments or bricks that are often sized to fit through the column access ports or manways. Structured packing is usually installed within the column in a plurality of layers of about 8 inches (˜204 mm) to about 12 inches (˜305 mm) high and with adjacent layers rotated between 45-90 degrees. The vertical edge of each packing sheet is distinguished by the motion it imparts to liquid flowing on the respective edge. Some packing sheets are configured such that liquid flow at the vertical edge is directed inwards while neighboring packing sheets would have a vertical edge whose corrugations direct liquid flow in an outward direction towards the vertical wall surface.

Persons skilled in the art of distillation column design have long recognized the deleterious effect of excessive liquid flow along the column wall and there have been attempts to mitigate that effect, such as use of conventional wall wipers or wiper tabs. Such wall wipers or wiper tabs are located around the perimeter of each layer and provides a contact seal between the structured packing and the column wall and directs descending liquid from the column wall and back into the structured packing.

While such conventional wiper tabs provide a generally effective solution to redirecting the descending liquid flow from the wall of the column back to the flow channels within the structured packing, there remains a problem with vapor bypass occurring along the column wall between the wiper tabs. Specifically, ascending vapor can bypass the structured packing through the gaps between the structured packing and the column wall in many distillation columns, which may lead to a sharp decline in the efficiency of the structured packing thus resulting in an adverse impact to the purity of products taken from the distillation column.

The deleterious effect of vapor bypass at the column wall has previously been addressed by the use of solid metal wall wipers or other restricting devices in the annular space near the column wall. One such example of using wiper tabs or wall wipers is briefly discussed in U.S. Pat. No. 5,700,403 where specially designed wall wipers are contemplated for use where such wall wipers encroach into voids or gaps of the structured packing sheets. Examples of other restricting devices such as solid wipers or gaskets disposed between the structured packing and the column wall are disclosed in the European Patent Application No. 0997189 A1 entitled “Devices to Minimize Vapor Bypass in Packed Column and Method of Assembly”.

However, recent laboratory testing has revealed the existence of significant vapor bypass in column arrangements if the measurement of the annular gap between the column wall and the structured packing is high and even in situations where the wiper tabs are still engaged with the column wall and the structured packing segments.

What is needed, therefore, is a structured packing arrangement that minimizes vapor bypass along walls of a distillation column between the wiper tabs or even eliminates the need for wiper tabs.

### SUMMARY OF THE INVENTION

The present invention may be characterized as a structured packing assembly or arrangement for a packed column, the structured packing arrangement comprising: (i) a plurality of end structured packing elements having an interior section of corrugated and perforated metal sheets and a defined perimeter at an edge of the end structured packing elements, wherein the defined perimeter of each of the plurality of end structured packing elements is configured to be disposed proximate to an interior surface of a packed column; and (ii) a shroud attached to one or more exposed portions of the defined perimeter of each of the end structured packing elements such that the shroud is disposed in the gap. Using the above structured packing assembly or arrangement, a first pressure drop of an ascending vapor stream in the packed column across the vertical height of the interior sections of the plurality of end structured packing elements should be less than a second pressure drop of the ascending vapor stream across the vertical height of the shroud filled gaps between the defined perimeters of the plurality of end structured packing elements and the interior surface of the packed column.

The present invention may also be characterized as a method of reducing vapor bypass in a packed column comprising the steps of: (a) attaching a shroud to a defined perimeter of a plurality of end structured packing elements; (b) assembling the plurality of end structured packing elements within the packed column such that there is a gap between the defined perimeters of the plurality of end structured packing elements and an interior surface a the packed column and wherein the should fills or partially fills said gap; and (c) operating the packed column by passing an ascending vapor stream and a descending liquid stream through the packed column having the plurality of end structured packing elements with the attached shroud to facilitate mass transfer between the ascending vapor stream and the descending liquid stream. As discussed above, the method yields a first pressure drop of the ascending vapor stream in the packed column across the vertical height of the plurality of end structured packing elements that is less than a second pressure drop of the ascending vapor stream across the vertical height of the shroud filled gaps between the defined perimeters of the plurality of end structured packing elements and the interior surface of the packed column. As a result of the difference between the first pressure drop and the second pressure drop, ascending vapor within the packed column passing through the plurality of end structured packing elements will tend to remain in the plurality of end structured packing elements and not enter the gap.

The preferred structured packing arrangement and associated method employs structured packing elements having a vertical height of not less than 100.0 mm and a gap between defined perimeters of the plurality of end structured packing elements and the interior surface of the packed column of between about 2.0 mm and 25.0 mm.

The structured packing arrangement and associated method also preferably utilize a shroud has a thickness of between about 2.0 mm and 25.0 mm and a height less than the vertical height of the end structured packing elements. The shroud may be a high density mass transfer medium such as a layer or multiple layers of gauze packing or a dense wire mesh. The shroud may be disposed below the wiper tabs or in embodiments that use multiple sets of wiper tabs, the shroud may be disposed between the first set of wiper tabs and the second set of wiper tabs.

### BRIEF DESCRIPTION OF THE DRAWINGS

While the specification concludes with one or more claims specifically pointing out the subject matter that Applicants regard as the invention, it is believed that the invention will be better understood when taken in connection with the accompanying drawing in which:

FIG. 1 depicts a partial, cross-section view of a section of a distillation column employing structured packing as a means for mass-transfer together with and in accordance with one embodiment of the structured packing arrangement; and

FIG. 2 depicts a graph comparing the column efficiency as expressed in HETP for a structured packing arrangement in accordance with an embodiment of the present structured packing arrangement with a shroud compared to a similar structured packing arrangement without a shroud.

### DETAILED DESCRIPTION

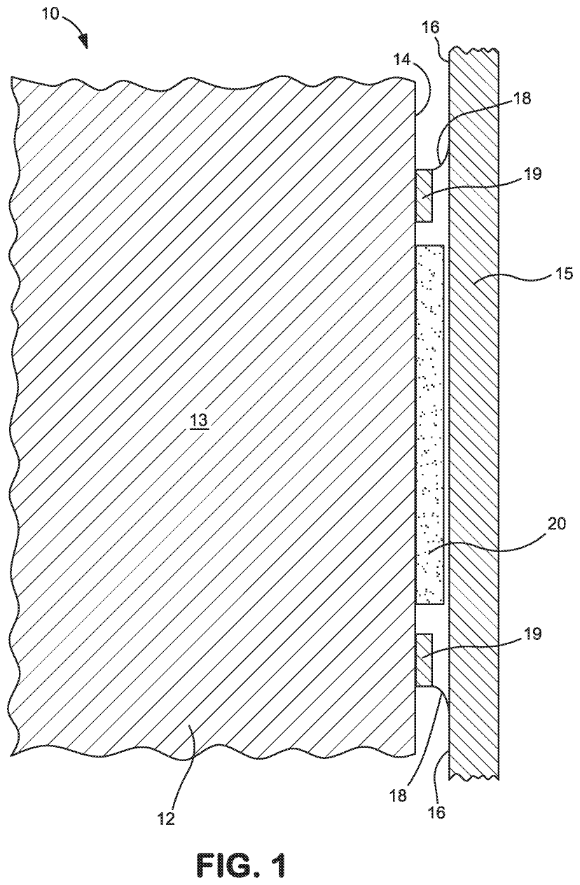

With reference to the FIG. 1, there is shown a cross-sectional cut-away view of a section of a distillation column employing structured packing as a means for mass-transfer. As seen therein, the illustrated distillation column arrangement includes one or more beds of structured packing elements 12 all disposed within an interior column region of the distillation column. The structured packing is typically installed within the distillation column as close as possible to the interior surface 16 of the column wall 15 to minimize liquid maldistribution and vapor bypass along the column wall 15.

The preferred embodiments include structured packing that is generally formed from corrugated sheets of perforated metal or plastic. The resulting structure is a very open honeycomb-like structure with inclined flow channels of the corrugations giving a relatively high surface area but with very low resistance to gas flow. In applications using structured packing, the structured packing is preferably constructed of materials selected from the group consisting of: aluminum sheet metal; stainless steel sheet metal; stainless steel gauze; copper gauze; and plastic. The surfaces of the structured packing may be smooth or may include surface texturing such as grooving, fluting, or patterned impressions on the surfaces of the structured packing sheets. Examples of the preferred types of structured packing are shown and described in U.S. Pat. Nos. 5,632,934 and 9,295,925.

The size or configuration of structure packing is broadly defined by the surface area density of the packing and the inclination angle of the corrugated flow channels in the main mass transfer section of the structured packing. The preferred density of the structured packing is between about 100 m²/m³ to 1300 m²/m³. The geometry of the structure packing, as characterized by the inclination angle of the corrugated flow channels in the main mass transfer section of the structured packing, preferably includes a nominal inclination angle to the horizontal axis of between about 35° to 70°. The preferred structured packing arrangement or configuration includes a plurality of conventional rectangular bricks. The preferred height of the bricks is between about 4 inches (˜204 mm) and 12 inches (˜305 mm),

The structured packing arrangement preferably comprise two or more beds of structured packing. In addition, where multiple beds of structured packing are employed, the adjacent beds may have the same or different surface area densities and/or different geometries. For example, a first bed of structured packing elements having a first surface area density while a second bed structured packing elements having a second surface area density may be disposed above or below the first bed of structured packing elements. Similarly, the first bed of structured packing elements may have a first nominal inclination angle to the horizontal axis whereas the second bed of structured packing elements may have a different nominal inclination angle to the horizontal axis.

A high pressure drop shroud 20 is wrapped around or otherwise attached to all or a portion of the perimeter 14 of the structured packing elements 12 to further minimize vapor bypass along the column wall 15. The high pressure drop shroud 20 urges the vapor flowing at or near the edges of the structured packing elements 12 to stay within the structured packing elements 12 and/or flow back through the flow channels in the structured packing instead of escaping through the side of the structured packing toward the column wall 15. Ascending vapor escaping through the sides of conventional structured packing elements 12 enters the gap between the column wall 15 and the structured packing resulting in vapor bypass.

A high pressure drop shroud 20, for example a layer of gauze, is preferably wrapped around the perimeter 14 of the structured packing element 12 between adjacent wiper band assemblies, which may include wiper tabs 18 and wiper band spacers 19. If wiper band assemblies are not employed, the high pressure drop shroud 20 would be wrapped around the perimeter 14 of the structured packing elements 12 between the inner surface 16 of the column wall 15 and the perimeter 14 of the structured packing elements. In either arrangement, the high pressure drop shroud 20 acts to increase the pressure drop of any vapor flowing within the gap. As a result, ascending vapor encountering the shroud 20 will tend to flow to back into the interior section 13 of structured packing elements 12 which represents a less restrictive flow path (i.e. lower pressure drop) than the shroud filled gap and hence forces or at least urges the ascending vapor to flow back through the structured packing element 12, resulting in increased efficiency of the mass transfer occurring within the distillation column.

The shroud material itself is preferably a known high density mass transfer medium, such as gauze packing, to allow or at least facilitate some degree of mass transfer occurring between any liquid and vapor flowing in the shroud. Depending on the material selected for the high pressure drop shroud and its ability to direct any downflowing liquid from the column wall back into the structured packing, such arrangement may potentially replace the conventional wiper bands or wiper tabs.

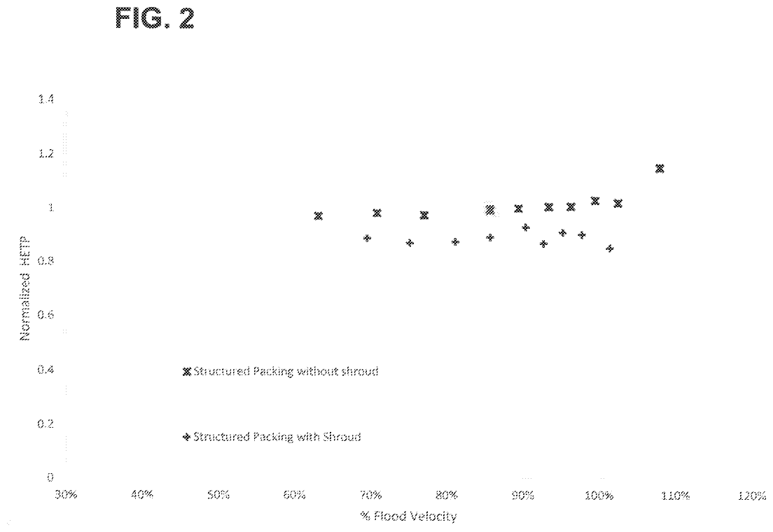

Turning now to FIG. 2, there is shown a graph depicting comparison between structured packing assembly in accordance with the present embodiment of the invention (i.e. including a high density mass transfer shroud) and similar structured packing assembly without the shroud.

The comparative examples show test data from a 12 inch diameter column operating at a nominal pressure of 22.0 psia configured for separating oxygen and argon at various vapor flow rates. The 12 inch diameter distillation column was packed with either: (i) Structured packing without a shroud; or (ii) Structured packing with shroud, namely a few layers of high density gauze packing.

FIG. 2 depicts the improvement in separation efficiency as expressed in terms of relative HETP for the structured packing with a few layers of high density gauze packing as a shroud compared to the structured packing without a shroud. The measured EIETP for both structured packing arrangements is normalized with the average measured EIETP of the structured packing arrangement without a shroud and is plotted against vapor flow rate expressed as a percentage of flood velocity. Normalized HETP for the structured packing arrangement with a shroud ranged from 0.8 to 0.9 depending on the vapor flow where as the normalized HETP for the structured packing arrangement without the shroud ranged from 1.0 to 1.15, indicating an improvement in column efficiency for the structured packing arrangement with the shroud.

While the present invention has been described with reference to a preferred embodiment or embodiments, it is understood that numerous additions, changes and omissions can be made without departing from the spirit and scope of the present invention as set forth in the appended claims.

1. A structured packing arrangement for a packed column, the structured packing arrangement comprising:
a plurality of end structured packing elements, each end structured packing element having a vertical height of not less than about 100.0 mm and defining an interior section of corrugated and perforated metal sheets and a defined perimeter at an edge of the corrugated and perforated metal sheets, wherein the defined perimeter of each of the plurality of end structured packing elements is configured to be disposed proximate to an interior surface of a packed column to define a gap between 2.0 mm and 25.0 mm between the defined perimeters of the plurality of end structured packing elements and the interior surface of the packed column; and
a shroud attached to one or more exposed portions of the defined perimeter of each of the end structured packing elements such that the shroud is disposed in the gap;
wherein a first pressure drop of an ascending vapor stream in the packed column across the vertical height of the interior sections of the plurality of end structured packing elements is less than a second pressure drop of the ascending vapor stream across the vertical height of the shroud filled gaps between the defined perimeters of the plurality of end structured packing elements and the interior surface of the packed column.

2. The structured packing arrangement of claim 1, wherein the shroud has a thickness between about 2.0 mm and 25.0 mm.

3. The structured packing arrangement of claim 1, wherein the shroud has a height less than the vertical height of each of the end structured packing elements.

4. The structured packing arrangement of claim 1, wherein the shroud is a high density mass transfer medium.

5. The structured packing arrangement of claim 4, wherein the shroud is a layer of gauze packing.

6. The structured packing arrangement of claim 4, wherein the shroud is a layer of wire mesh.

7. The structured packing arrangement of claim 1, further comprising:
one or more spacer tabs connected to the defined perimeters of each of the plurality of end structured packing elements; and
a plurality wiper tabs connected to the one or more spacer tabs and each wiper tab extending away from the defined perimeters at an initial bend angle between about 20 degrees and about 45 degrees.

8. The structured packing arrangement of claim 7, wherein the shroud is disposed below the plurality of wiper tabs.

9. The structured packing arrangement of claim 7, wherein the plurality of wiper tabs further comprise a first set of wiper tabs disposed proximate a top of each of the plurality of end structured packing elements and a second set of wiper tabs connected to a bottom of each of the plurality of end structured packing elements.

10. The structured packing arrangement of claim 9, wherein the shroud is disposed between the first set of wiper tabs and the second set of wiper tabs.

11. A method of reducing vapor bypass in a packed column comprising the steps of:
attaching a shroud to a defined perimeter of a plurality of end structured packing elements, each end structured packing element having a vertical height of not less than about 100.0 mm and defining an interior section of corrugated and perforated metal sheets and wherein the defined perimeter is an edge of the corrugated and perforated metal sheets configured to be disposed proximate to an interior surface of the packed column;
assembling the plurality of end structured packing elements within the packed column such that there is a gap between about 2.0 mm and 25.0 mm between the defined perimeters of the plurality of end structured packing elements and an interior surface of the packed column and wherein the shroud fills or partially fills said gap; and
passing an ascending vapor stream and a descending liquid stream through the packed column having the plurality of end structured packing elements with the attached shroud to facilitate mass transfer between the ascending vapor stream and the descending liquid stream;
wherein a first pressure drop of the ascending vapor stream in the packed column across the vertical height of the plurality of end structured packing elements is less than a second pressure drop of the ascending vapor stream across the vertical height of the shroud filled gaps between the defined perimeters of the plurality of end structured packing elements and the interior surface of the packed column; and
wherein ascending vapor within the packed column passing through the plurality of end structured packing elements will tend to remain in the plurality of end structured packing elements and not enter the gap due to the first pressure drop being less than the second pressure drop.

12. The method of claim 11, wherein the shroud has a thickness of about 2.0 mm.

13. The method of claim 11, wherein the shroud has a height less than the vertical height of each of the plurality of end structured packing elements.

14. The method of claim 11, wherein the gauze packing is a high density mass transfer medium.

15. The method of claim 14, wherein the shroud is a layer of gauze packing.

16. The method of claim 14, wherein the shroud is a layer of dense wire mesh.

17. The method of claim 11, wherein the shroud is disposed below a plurality of wiper tabs extending away from the defined perimeter at an initial bend angle between about 20 degrees and about 4 degrees.

18. The method of claim 11, wherein the shroud is disposed between a first set of wiper tabs disposed proximate a top of each of the plurality of end structured packing elements and a second set of wiper tabs connected to a bottom of each of the plurality of end structured packing elements.
